(19) United States
(12) Patent Application Publication
(10) Pub. No.: US 2015/0017497 A1
(43) Pub. Date: Jan. 15, 2015

(54) CATHODE ACTIVE SEGMENT FOR AN ELETROCHEMICAL CELL

(71) Applicant: The Gillette Company, Boston, MA (US)

(72) Inventor: William Fitler Morris, Newtown, CT (US)

(21) Appl. No.: 13/939,285

(22) Filed: Jul. 11, 2013

(51) Int. Cl. H01M 4/02; H01M 4/50

(52) U.S. Cl. CPC H01M 4/02; H01M 4/50; H01M 2004/025; H01M 2220/30
USPC 429/90; 429/209; 429/246; 429/224; 429/219; 429/223; 429/220; 429/218.1

(57) ABSTRACT

The invention is directed towards a cathode active segment for an electrochemical cell. The cathode active segment includes at least one cathode active material, a cross-sectional width including a first curvilinear surface, a second curvilinear surface, a longitudinal length, and at least one cathode mating surface. The at least one cathode mating surface extends along the longitudinal length of the cathode active segment.

### FIELD OF THE INVENTION

The invention relates to a cathode, and more specifically a cathode segment, for an electrochemical cell.

### BACKGROUND OF THE INVENTION

Electrochemical cells, or batteries, are commonly used as electrical energy sources. A battery contains a negative electrode, typically called the anode, and a positive electrode, typically called the cathode. The anode contains an active material that can be oxidized. The cathode contains an active material that can be reduced. The anode active material is capable of reducing the cathode active material. A separator is disposed between the anode and cathode. These components are disposed in a can, or housing, that is typically made from metal.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the anode and cathode to maintain charge balance throughout the battery during discharge.

There is a growing need to make batteries better suitable to power contemporary electronic devices such as toys; remote controls; audio devices; flashlights; digital cameras and peripheral photography equipment; electronic games; toothbrushes; radios; and clocks. To meet this need, batteries may include higher loading of anode and cathode active materials to provide increased service life. Batteries, however, also come in common sizes, such as the AA, AAA, AAAA, C, and D battery sizes, that have fixed external dimensions and constrained internal volumes. The ability to increase active material loading alone to achieve better performing batteries is thus limited.

The interfacial area between the anode and cathode active materials is another design feature, however, that may be adjusted in order to provide performance improvement within the aforementioned constraints. One potential method of increasing the interfacial surface area between the anode and cathode active materials within cylindrical batteries is, for example, to include features, such as humps, on the internal surface of the cathode electrode pellets. The inclusion of such features, however, requires aligning the pellets so that the humps are appropriately ordered. Aligning the pellets increases the production time and thus the overall cost to produce a battery. Also, inserting a separator into a battery housing that holds aligned pellets with surface features is problematic. An excess amount of separator, for example, is generally required to adequately minimize the potential for electrical shorting between the anode and the cathode. The excess separator increases the internal battery resistance which leads to a reduction in battery performance. The excess separator also increases material cost for the battery. In addition, the separator insertion process generally increases the production time and overall cost of the battery. There exists a need to provide an increased interfacial area between the anode and cathode active materials within a battery that eliminates: a need for pellet alignment, difficulties associated with separator insertion, and a need for excess separator to increase overall battery performance, including power capability and service life.

### SUMMARY OF THE INVENTION

In one embodiment, the invention is directed towards a cathode active segment for an electrochemical cell. The cathode active segment includes at least one cathode active material, a cross-sectional width including a first curvilinear surface, a second curvilinear surface, a longitudinal length, and at least one cathode mating surface. The at least one cathode mating surface extends along the longitudinal length of the cathode active segment.

In another embodiment, the invention is directed towards a cathode assembly for an electrochemical cell. The cathode assembly includes a first cathode active segment and a second cathode active segment. The first cathode active segment includes at least one cathode active material, a cross-sectional width including a first curvilinear surface, a second curvilinear surface, a longitudinal length, and at least one cathode mating surface that extends along the longitudinal length. The second cathode active segment includes at least one cathode active material, a cross-sectional width including a first curvilinear surface, a second curvilinear surface, a longitudinal length, and at least one cathode mating surface that extends along the longitudinal length. The at least one cathode mating surface of the first cathode active segment is positioned adjacent to the at least one cathode mating surface of the second cathode active segment.

In another embodiment, the invention is directed towards an electrochemical cell. The electrochemical cell includes a housing having an outer surface and a label affixed to the outer surface. The housing includes an anode, a cathode assembly, a separator between the anode and the cathode assembly, and an electrolyte. The cathode assembly includes a first cathode active segment and a second cathode active segment. The first cathode active segment includes at least one cathode active material, a cross-sectional width including a first curvilinear surface, a second curvilinear surface, a longitudinal length, and at least one cathode mating surface that extends along the longitudinal length. The second cathode active segment includes at least one cathode active material, a cross-sectional width including a first curvilinear surface, a second curvilinear surface, a longitudinal length, and at least one cathode mating surface that extends along the longitudinal length. The at least one cathode mating surface of the first cathode active segment is positioned adjacent to the at least one cathode mating surface of the second cathode active segment. The label includes a voltage tester.

### BRIEF DESCRIPTION OF THE DRAWINGS

While the specification concludes with claims particularly pointing out and distinctly claiming the subject matter, which is regarded as forming the present invention, it is believed that the invention will be better understood from the following description taken in conjunction with the accompanying drawings.

FIG. 1 is a cross-section of an electrochemical cell including a cathode assembly of the present invention.

FIG. 2 is a perspective view of a cathode assembly of the present invention.

FIG. 3 is another perspective view of a cathode assembly of the present invention.

FIG. 4 is a cross-section view of a battery including a cathode assembly of the present invention.

FIG. 5 is a perspective view of another embodiment of a cathode assembly of the present invention.

FIG. 6 is another perspective view of another embodiment of a cathode assembly of the present invention.

FIG. 7 is a cross-section view of a battery including another embodiment of a cathode assembly of the present invention.

FIG. 8 is a view of a finished battery including a cathode assembly of the present invention.

### DETAILED DESCRIPTION OF THE INVENTION

Electrochemical cells, or batteries, may be primary or secondary. Primary batteries are meant to be discharged, e.g., to exhaustion, only once and then discarded. Primary batteries are described, for example, in David Linden, Handbook of Batteries (McGraw-Hill, 4th ed. 2011). Secondary batteries are intended to be recharged. Secondary batteries may be discharged and then recharged many times, e.g., more than fifty times, a hundred times, or more. Secondary batteries are described, e.g., David Linden, Handbook of Batteries (McGraw-Hill, 4th ed. 2011). Accordingly, batteries may include various electrochemical couples and electrolyte combinations. Although the description and examples provided herein are generally directed towards primary alkaline electrochemical cells, or batteries, it should be appreciated that the invention applies to both primary and secondary batteries of either aqueous or nonaqueous systems. Both primary and secondary batteries of either aqueous or nonaqueous systems are thus within the scope of this application and the invention is not limited to any particular embodiment.

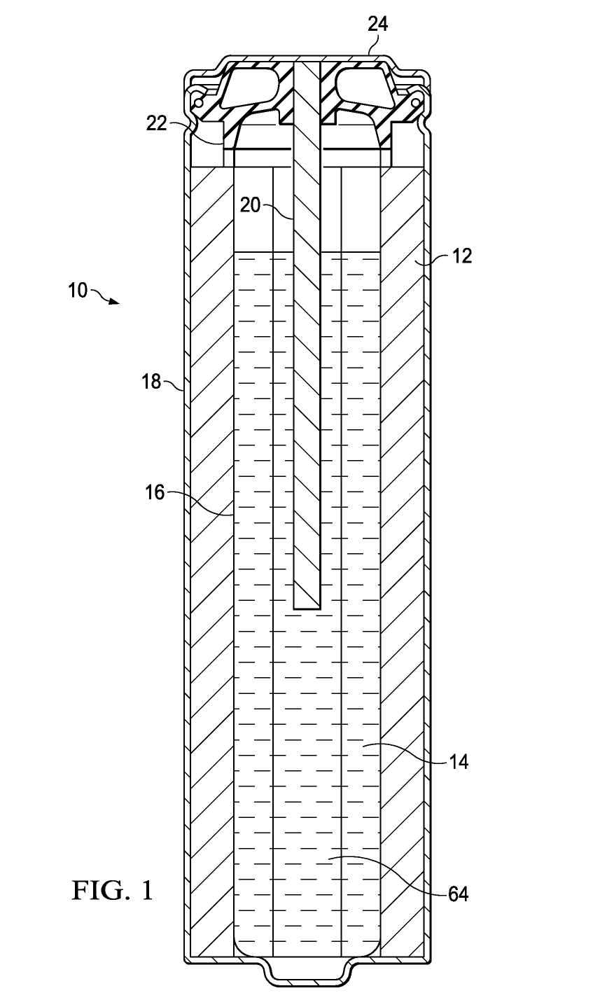

Referring now to FIG. 1, there is shown an electrochemical cell, or battery, 10 including a cathode 12 with a lobe 64, an anode 14, a separator 16, and a housing 18. Battery 10 also includes current collector 20, seal 22, and an end cap 24. An electrolytic solution (not shown) is dispersed throughout the battery 10. Battery 10 can be, for example, a AA, AAA, AAAA, C, or D alkaline battery.

The housing 18 can be of any conventional type of housing commonly used in primary alkaline batteries and can be made of any suitable material, for example cold-rolled steel or nickel-plated cold-rolled steel. The housing 18 may have a cylindrical shape—or may have any other suitable non-cylindrical shape, e.g., a prismatic shape for example, a shape comprising at least two parallel plates, such as a rectangular or square shape. The housing 18 may be, for example, deep-drawn from a sheet of the base material, such as cold-rolled steel or nickel-plated steel. The housing 18 may be, for example, drawn into a cylindrical shape. The finished housing 18 may have at least one open end. The finished housing 18 may have a closed end and an open end with a sidewall therebetween. The interior walls of the housing 18 may be treated with a material that provides a low electrical-contact resistance between the interior wall of the housing 18 and an electrode. The interior walls of the housing 18 may be plated, e.g., with nickel, cobalt, and/or painted with a carbon-loaded paint to decrease contact resistance between the internal wall of the housing and the cathode 12.

Cathode 12 includes one or more electrochemically active cathode materials. The electrochemically active cathode material may include manganese oxide, manganese dioxide, electrolytic manganese dioxide (EMD), chemical manganese dioxide (CMD), high power electrolytic manganese dioxide (HP EMD), lambda manganese dioxide, gamma manganese dioxide, beta manganese dioxide, and mixtures thereof. Other electrochemically active cathode materials include, but are not limited to, silver oxide; nickel oxide; nickel oxyhydroxide; copper oxide; copper salts, such as copper iodate; bismuth oxide; high-valence nickel compound; oxygen; alloys thereof, and mixtures thereof. The nickel oxide can include nickel hydroxide, nickel oxyhydroxide, cobalt oxyhydroxide-coated nickel oxyhydroxide, delithiated layered lithium nickel oxide, and combinations thereof. The nickel hydroxide or oxyhydroxide can include beta-nickel oxyhydroxide, gamma-nickel oxyhydroxide, and/or intergrowths of beta-nickel oxyhydroxide and/or gamma-nickel oxyhydroxide. The cobalt oxyhydroxide-coated nickel oxyhydroxide can include cobalt oxyhydroxide-coated beta-nickel oxyhydroxide, cobalt oxyhydroxide-coated gamma-nickel oxyhydroxide, and/or cobalt oxyhydroxide-coated intergrowths of beta-nickel oxyhydroxide and gamma-nickel oxyhydroxide. The nickel oxide can include a partially delithiated layered nickel oxide having the general chemical formula Li₁₋ₓH_{y}NiO₂, wherein 0.1≦x≦0.9 and 0.1≦y≦0.9. The high-valence nickel compound may, for example, include tetravalent nickel.

The cathode 12 may also include a conductive additive, such as carbon particles, and a binder. The cathode 12 may also include other additives. The cathode 12 will have a porosity that may be calculated, at the time of manufacture, by the following formula:

Cathode Porosity=(1−(cathode solids volume÷cathode volume))×100

The cathode porosity may be from about 15% to about 45% and is preferably between about 22% and about 35%. The porosity of the cathode is typically calculated at the time of manufacturing since the porosity will change over time due to, inter alia, cathode swelling associated with electrolyte wetting of the cathode and battery discharge.

The carbon particles are included in the cathode to allow the electrons to flow through the cathode. The carbon particles may be graphite, such as expanded graphite and natural graphite; graphene, single-walled nanotubes, multi-walled nanotubes, carbon fibers; carbon nanofibers; and mixtures thereof. It is preferred that the amount of carbon particles in the cathode is relatively low, e.g., less than about 7.0%, less than 3.75%, or even less than 3.5%, for example 2.0% to 3.5%. The lower carbon level enables inclusion of a higher loading of active material within the cathode without increasing the volume of the cell or reducing the void volume (which must be maintained at or above a certain level to prevent internal pressure from rising too high as gas is generated within the cell). Suitable expanded graphite for use within a battery can be obtained, for example, from Timcal.

It is generally preferred that the cathode be substantially free of nonexpanded graphite. While nonexpanded graphite particles provide lubricity to the cathode pellet forming equipment, this type of graphite is significantly less conductive than expanded graphite, and thus it is necessary to use more nonexpanded graphite in order to obtain the same cathode conductivity of a cathode containing expanded graphite. While not preferred, the cathode may include low levels of unexpanded graphite, however this will compromise the reduction in graphite concentration that can be obtained while maintaining a particular cathode conductivity.

The cathode components, such as active cathode material(s), carbon particles, binder, and any other additives, may be combined with a liquid, such as an aqueous potassium hydroxide electrolyte, blended, and pressed into pellets for use in the manufacture of a finished battery. For optimal pellet processing, it is generally preferred that the cathode material have a moisture level in the range of about 2.5% to about 5%, more preferably about 2.8% to about 4.6%. The pellets, after being placed within a battery housing during the battery assembly process, are typically re-compacted to form a uniform cathode assembly.

Examples of binders that may be used in the cathode 12 include polyethylene, polyacrylic acid, or a fluorocarbon resin, such as PVDF or PTFE. An example of a polyethylene binder is sold under the trade name COATHYLENE HA-1681 (available from Hoechst or DuPont).

Examples of other cathode additives are described in, for example, U.S. Pat. Nos. 5,698,315, 5,919,598, and 5,997,775 and 7,351,499, all hereby incorporated by reference.

The amount of electrochemically active cathode material within the cathode 12 may be referred to as the cathode loading. The loading of the cathode 12 may vary depending upon the electrochemically active cathode material used within, and the cell size of, the battery. For example, AA batteries with a manganese dioxide electrochemically active cathode material may have a cathode loading of at least 9.0 grams of manganese dioxide. The cathode loading may be, for example, at least about 9.5 grams of manganese dioxide. The cathode loading may be, for example, between about 9.7 grams and about 11.5 grams of manganese dioxide. The cathode loading may be from about 9.7 grams and about 11.0 grams of manganese dioxide. The cathode loading may be from about 9.8 grams and about 11.2 grams of manganese dioxide. The cathode loading may be from about 9.9 grams and about 11.5 grams of manganese dioxide. The cathode loading may be from about 10.4 grams and about 11.5 grams of manganese dioxide. For a AAA battery, the cathode loading may be from about 4.0 grams and about 6.0 grams of manganese dioxide. For a AAAA battery, the cathode loading may be from about 2.0 grams and about 3.0 grams of manganese dioxide. For a C battery, the cathode loading may be from about 25.0 grams and about 29.0 grams of manganese dioxide. For a D battery, the cathode loading may be from about 54.0 grams and about 70.0 grams of manganese dioxide.

Anode 14 can be formed of at least one electrochemically active anode material, a gelling agent, and minor amounts of additives, such as organic and/or inorganic gassing inhibitor. The electrochemically active anode material may include zinc; zinc oxide; zinc hydroxide; cadmium; iron; metal hydride, such as AB₅(H), AB₂(H), and A₂B₇(H); alloys thereof; and mixtures thereof.

The amount of electrochemically active anode material within the anode 14 may be referred to as the anode loading. The loading of the anode 14 may vary depending upon the electrochemically active anode material used within, and the cell size of, the battery. For example, AA batteries with a zinc electrochemically active anode material may have an anode loading of at least about 3.3 grams of zinc. The anode loading may be, for example, at least about 4.0, about 4.3, about 4.6 grams, about 5.0 grams, or about 5.5 grams of zinc. The anode loading may be between about 4.0 grams and 5.5 grams of zinc. The anode loading may be between about 4.2 grams and 5.2 grams of zinc. AAA batteries, for example, with a zinc electrochemically active anode material may have an anode loading of at least about 1.9 grams of zinc. For example, the anode loading may have at least about 2.0 or about 2.1 grams of zinc. AAAA batteries, for example, with a zinc electrochemically active anode material may have an anode loading of at least about 0.6 grams of zinc. For example, the anode loading may have at least about 0.7 to about 1.0 grams of zinc. C batteries, for example, with a zinc electrochemically active anode material may have an anode loading of at least about 9.5 grams of zinc. For example, the anode loading may have at least about 10.0 to about 15.0 grams of zinc. D batteries, for example, with a zinc electrochemically active anode material may have an anode loading of at least about 19.5 grams of zinc. For example, the anode loading may have at least about 20.0 to about 30.0 grams of zinc.

Examples of a gelling agent that may be used include a polyacrylic acid; a polyacrylic acid cross-linked with polyalkenyl ether of divinyl glycol, such as Carbopol; a grafted starch material; a salt of a polyacrylic acid; a carboxymethylcellulose; a salt of a carboxymethylcellulose (e.g., sodium carboxymethylcellulose); or combinations thereof. The anode may include a gassing inhibitor that may include an inorganic material, such as bismuth, tin, or indium. Alternatively, the gassing inhibitor can include an organic compound, such as a phosphate ester, an ionic surfactant or a nonionic surfactant.

An electrolyte may be dispersed throughout the cathode 12, the anode 14 and the separator 16. The electrolyte comprises an ionically conductive component in an aqueous solution. The ionically conductive component may be a hydroxide. The hydroxide may be, for example, sodium hydroxide, potassium hydroxide, lithium hydroxide, cesium hydroxide, and mixtures thereof. The ionically conductive component may also include a salt. The salt may be, for example, zinc chloride, ammonium chloride, magnesium perchlorate, magnesium bromide, and mixtures thereof. The concentration of the ionically conductive component may be selected depending on the battery design and its desired performance. An aqueous alkaline electrolyte may include a hydroxide, as the ionically conductive component, in a solution with water. The concentration of the hydroxide within the electrolyte may be from about 0.25 to about 0.40, or from about 25% to about 40%, on a total weight basis of the electrolyte. For example, the hydroxide concentration of the electrolyte may be from about 0.25 to about 0.32, or from about 25% to about 32%, on a total weight basis of the electrolyte. The aqueous alkaline electrolyte may also include zinc oxide (ZnO) dissolved within it. The ZnO may serve to suppress zinc corrosion within the anode. The concentration of ZnO included within the electrolyte may be less than about 3% by weight of the electrolyte. The ZnO concentration, for example, may be from about 1% by weight to about 3% by weight of the electrolyte.

The total weight of the aqueous alkaline electrolyte within a AA alkaline battery, for example, may be from about 3.0 grams to about 4.0 grams. The weight of the electrolyte within a AA battery preferably may be, for example, from about 3.3 grams to about 3.8 grams. The weight of the electrolyte within a AA battery may more preferably, for example, from about 3.4 grams to about 3.65 grams. The total weight of the aqueous alkaline electrolyte within a AAA alkaline battery, for example, may be from about 1.0 grams to about 2.0 grams. The weight of the electrolyte within a AAA battery preferably may be, for example, from about 1.2 grams to about 1.8 grams. The weight of the electrolyte within a AAA battery may more preferably, for example, from about 1.4 grams to about 1.6 grams.

Separator 16 comprises a material that is wettable or wetted by the electrolyte. A material is said to be wetted by a liquid when the contact angle between the liquid and the surface is less than 90° or when the liquid tends to spread spontaneously across the surface; both conditions normally coexist. Separator 16 may comprise woven or nonwoven paper or fabric. Separator 16 may include a layer of, for example, cellophane combined with a layer of non-woven material. The separator also can include an additional layer of non-woven material. Separator 16 may also be formed in situ within the battery 10. U.S. Pat. No. 6,514,637, for example, discloses such separator materials, and potentially suitable methods of their application, and is hereby incorporated by reference in its entirety. The separator material may be thin. The separator, for example, may have a dry thickness of less than 250 micrometers (microns). The separator, for example, may have a dry thickness of less than 100 microns. The separator preferably has a dry thickness from about 70 microns to about 90 microns, more preferably from about 70 microns to about 75 microns. Separator 16 has a basis weight of 40 g/m² or less. The separator preferably has a basis weight from about, 15 g/m² to about 40 g/m², and more preferably from about 20 g/m² to about 30 g/m². Separator 16 may have an air permeability value. Separator 16 may have an air permeability value as defined in ISO 2965. The air permeability value of Separator 16 may be from about 2000 cm³/cm²·min@1 kPa to about about 5000 cm³/cm²·min@1 kPa. The air permeability value of Separator 16 may be from about 3000 cm³/cm²·min@1 kPa to about 4000 cm³/cm²·min@1 kPa. The air permeability value of Separator 16 may be from about 3500 cm³/cm²·min@1 kPa to about 3800 cm³/cm²·min@1 kPa.

The current collector 20 may be made into any suitable shape for the particular battery design by any known methods within the art. The current collector 20 may have, for example, a nail-like shape. The current collector 20 may have a columnar body and a head located at one end of the columnar body. The current collector 20 may be made of metal, e.g., zinc, copper, brass, silver, or any other suitable material. The current collector 20 may be optionally plated with tin, zinc, bismuth, indium, or another suitable material presenting a low electrical-contact resistance between the current collector 20 and, for example, the anode 14 and an ability to suppress gas formation.

The seal 22 may be prepared by injection molding a polymer, such as polyamide, polypropylene, polyetherurethane, or the like; a polymer composite; and mixtures thereof into a shape with predetermined dimensions. The seal 22 may be made from, for example, Nylon 6,6; Nylon 6,10; Nylon 6,12; polypropylene; polyetherurethane; co-polymers; and composites and mixtures thereof. Exemplary injection molding methods include both the cold runner method and the hot runner method. Seal 22 may contain other known functional materials such as a plasticizer, crystalline nucleating agent, antioxidant, mold release agent, lubricant, and antistatic agent. The seal 22 may also be coated with a sealant. The seal 22 may be moisturized prior to use within the battery 10. The seal 22, for example, may have a moisture content of from about 1.0 weight percent to about 9.0 weight percent depending upon the seal material. The current collector 20 may be inserted into and through the seal 22.

The end cap 24 may function as the negative or positive terminal of battery 10. The end cap 24 may be formed in any shape sufficient to close the respective battery. The end cap 24 may have, for example, a cylindrical or prismatic shape. The end cap 24 may be formed by pressing a material into the desired shape with suitable dimensions. The end cap 24 may be made from any suitable material that will conduct electrons during the discharge of the battery 10. The end cap 24 may be made from, for example, nickel-plated steel or tin-plated steel. The end cap 24 may be electrically connected to the current collector 20. The end cap 24 may, for example, make electrical connection to the current collector 20 by being welded to the current collector 20. The end cap 24 may also include one or more apertures (not shown), such as holes, for venting any gas pressure that may build up under the end cap 24 during a gassing event within the battery 10, for example, during deep discharge or reversal of a battery within a device, that may lead to rupture of vent.

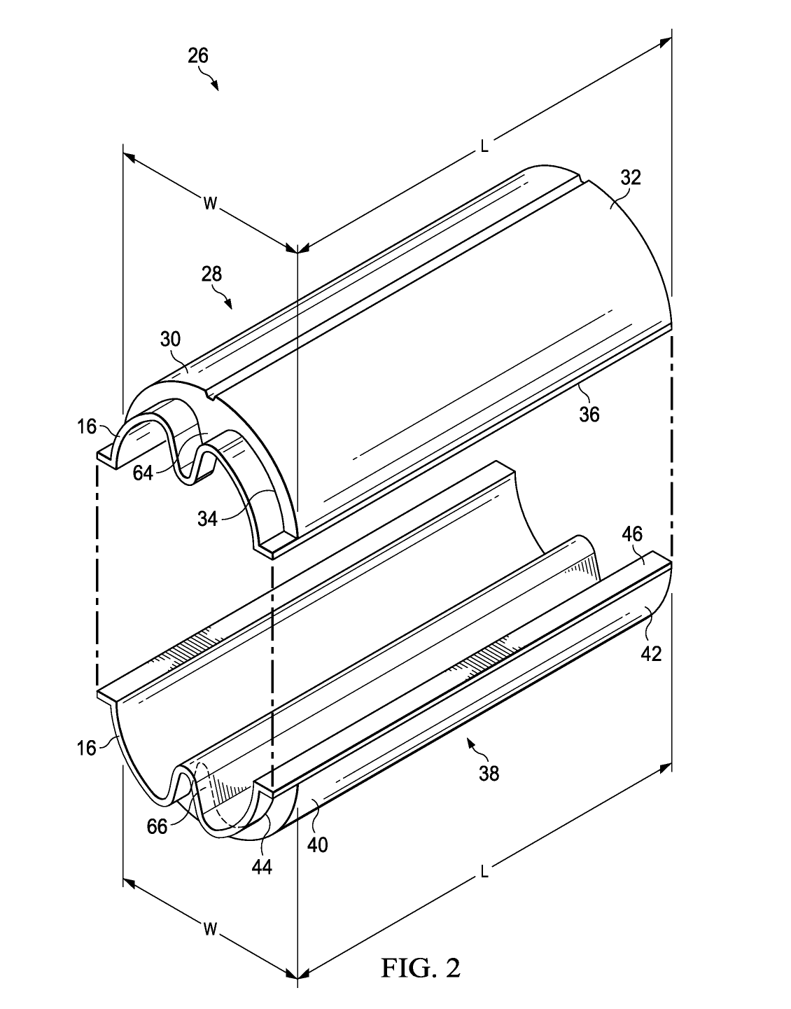

Referring now to FIGS. 2-7, there is shown a cathode assembly 26 for an electrochemical cell including at least a first cathode segment 28 and at least a second cathode segment 38.

The first cathode segment 28 has a first cathode active segment 30 and a separator 16. The first cathode active segment 30 may include at least one electrochemically active cathode material. The first cathode active segment 30 may be formed from a slurry of any viscosity suitable for processing that includes at least one electrochemically active cathode material; at least one conductive additive; a binder; and an electrolyte. The first cathode active segment 30 may be formed via compaction, pressing, extrusion, or any other suitable method. The cathode active material, conductive additive, binder, and electrolyte may be selected from any materials suitable for use within a battery and may be in any combination and amount suitable for use within a battery. Exemplary materials, combinations, porosities, and formulations are discussed above.

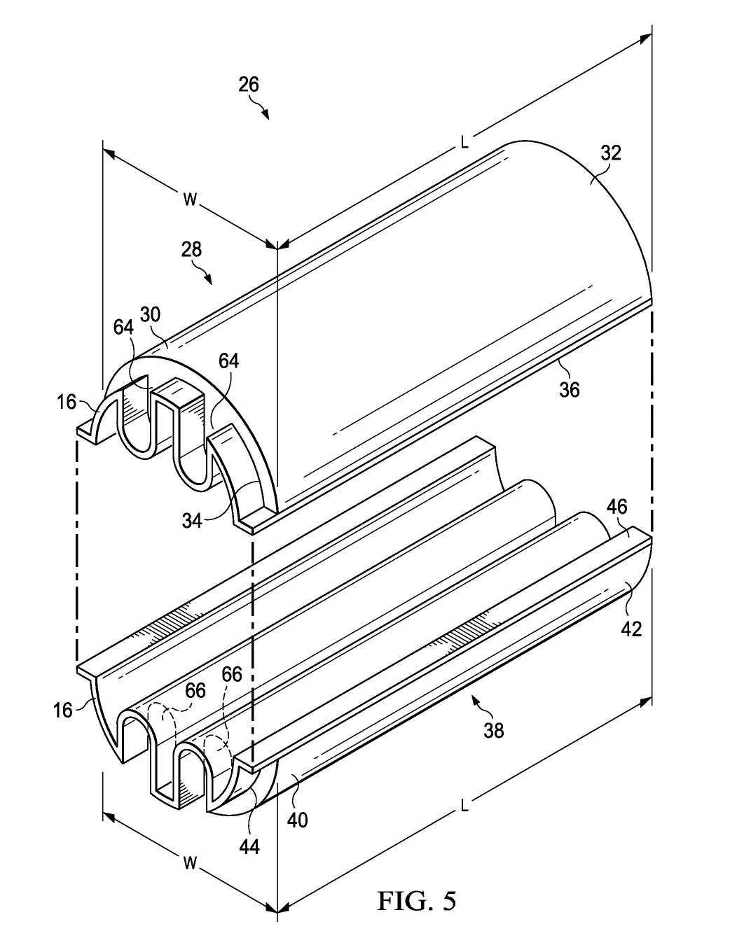

The first cathode active segment 30 has a first curvilinear surface 32; a second curvilinear surface 34; and at least one cathode mating surface 36. The first curvilinear surface 32 and the second curvilinear surface 34 may form an arc. The second curvilinear surface 34 may include at least one feature along the surface, such as a lobe 64. The second curvilinear surface 34 may include any number of features, such as one lobe (as in FIGS. 2-4), two lobes (as in FIGS. 5-7), three lobes, or any number of lobes, or any combination of features.

The first cathode active segment 30 has a cross-sectional width W and a longitudinal length L. The cross-sectional width W includes the first curvilinear surface 32 and the second curvilinear surface 34 of the first cathode active segment 30. The at least one cathode mating surface 36 extends along the longitudinal length L of the first cathode active segment 30. A separator 16 may be affixed to the at least one cathode mating surface 36 of the first cathode active segment 30. The separator 16 may be affixed to the at least one cathode mating surface 36 and the second curvilinear surface 34 of the first cathode active segment 30.

An adhesive (not shown) may be placed between the separator 16 and the at least one cathode mating surface 36 of the first cathode active segment 30. An adhesive (not shown) may be placed between the separator 16 and the at least one cathode mating surface 36 and the second curvilinear surface 34 of the first cathode active segment 30. The adhesive may be any suitable adhesive that will, at least, initially hold the separator 16 to the first cathode active segment 30. Suitable adhesives may be, for example, polyvinyl alcohol, hydroxyl ethyl cellulose, carboxy methyl cellulose (CMC), and cellulose acetate.

The second cathode segment 38 has a first cathode active segment 40 and a separator 16. The second cathode active segment 40 may include at least one electrochemically active cathode material. The second cathode active segment 40 may be formed from a slurry of any viscosity suitable for processing that includes at least one electrochemically active cathode material; at least one conductive additive; a binder; and an electrolyte. The second cathode active segment 40 may be formed via compaction, pressing, extrusion, or any other suitable method. The cathode active material, conductive additive, binder, and electrolyte may be selected from any conventional battery materials and may be in any combination and amount suitable for use within a battery. Exemplary materials, combinations, porosities, and formulations are discussed above.

The second cathode active segment 40 has a first curvilinear surface 42; a second curvilinear surface 44; and at least one cathode mating surface 46. The first curvilinear surface 42 and the second curvilinear surface 44 may form an arc. The second curvilinear surface 44 may include at least one feature along the surface, such as a lobe 66. The second curvilinear surface 44 may include any number of features, such as one lobe (as in FIGS. 2-4), two lobes (as in FIGS. 5-7), three lobes, or any number of lobes, or any combination of features.

The second cathode active segment 40 has a cross-sectional width W and a longitudinal length L. The cross-sectional width W includes the first curvilinear surface 42 and the second curvilinear surface 44 of the second cathode active segment 40. The at least one cathode mating surface 46 extends along the longitudinal length L of the second cathode active segment 40. The separator 16 may be affixed to the at least one cathode mating surface 46 of the second cathode active segment 40. The separator 16 may be affixed to the at least one cathode mating surface 46 and the second curvilinear surface 44 of the second cathode active segment 40. The separator 16 may comprise the same separator material as, or a different separator material than, the material selected for the first cathode segment 28.

An adhesive (not shown) may be placed between the separator 16 and the at least one cathode mating surface 46 of the second cathode active segment 40. An adhesive (not shown) may be placed between the separator 16 and the at least one cathode mating surface 46 and the second curvilinear surface 42 of the second cathode active segment 40. The adhesive may be any suitable adhesive that will, at least, initially hold the separator 16 to the second cathode active segment 40. Suitable adhesives may be, for example, polyvinyl alcohol, hydroxyl ethyl cellulose, carboxy methyl cellulose (CMC), and cellulose acetate.

The cathode assembly 26 may be formed by positioning the at least one cathode mating surface 36 of the first cathode active segment 30 opposite the at least one cathode mating surface 46 of the second cathode active segment 40. The at least one cathode mating surface 36 of the first cathode active segment 30 and the at least one cathode mating surface 46 of the second cathode active segment 40 may each have a separator 16 affixed thereto. The cathode mating surfaces of additional cathode segments may be positioned in a similar manner until the desired cathode assembly is complete. For example, a total of two cathode active segments, three cathode active segments, four cathode active segments, five cathode active segments, six cathode active segments, or any number of cathode active segments greater than one may be used to complete the cathode assembly 34.

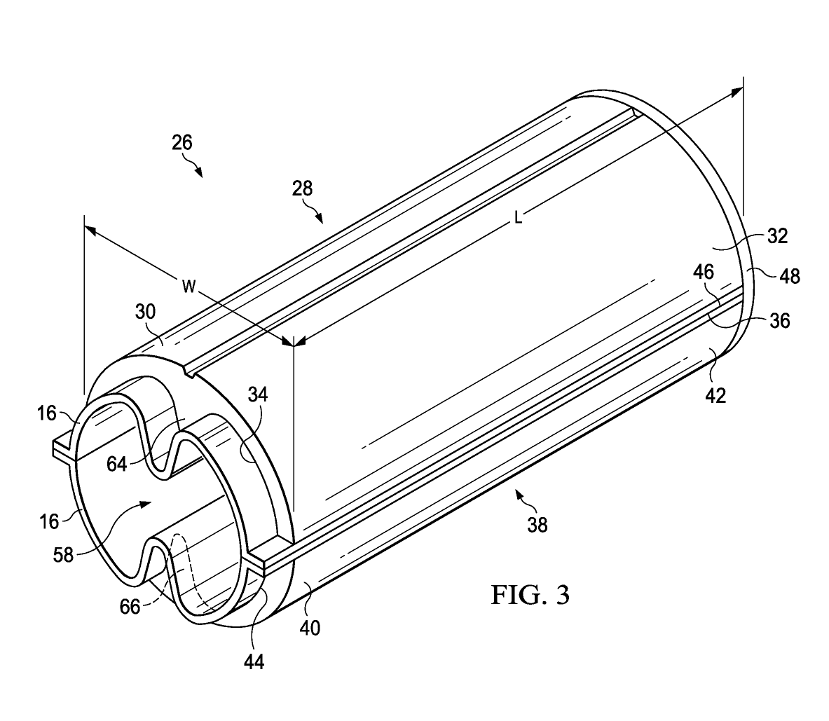

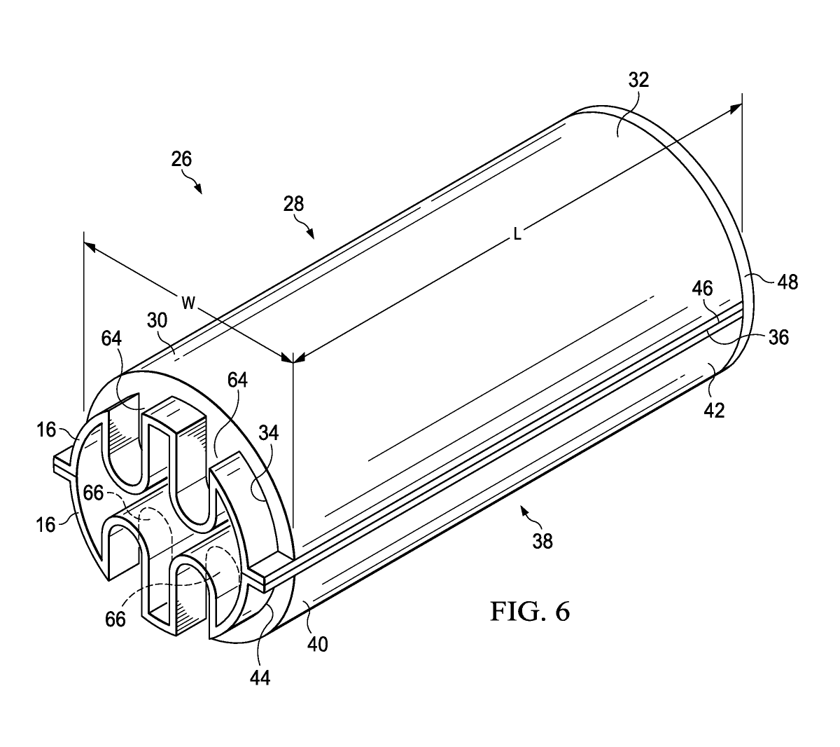

Referring now to FIGS. 3 and 6, there is shown a cathode assembly 26 that may be placed within a cylindrical housing of a battery (not shown) including a first cathode segment 28, a second cathode segment 38, and a separator disk 48.

The first cathode mating surface 50 of the first cathode active segment 30 is positioned opposite the first cathode mating surface 54 of the second cathode active segment 40. The second cathode mating surface 52 of the first cathode active segment 30 is positioned opposite the second cathode mating surface 56 of the second cathode active segment 40. The separator 16 may be affixed to the first cathode mating surface 50 and second cathode mating surface 52 of the first cathode active segment 30. The separator 16 may be affixed to the second curvilinear surface 34 of the first cathode active segment 30. The separator 16 may be affixed to the first cathode mating surface 54 and second cathode mating surface 56 of the second cathode active segment 40. The separator 16 may be affixed to the second curvilinear surface 44 of the second cathode active segment 40.

The top of the first cathode segment 28 and the top of the second cathode segment 38 are aligned so that a generally uniform and flat top surface for the cathode assembly 26 is formed. The bottom of the first cathode segment 28 and the bottom of the second cathode segment 38 are aligned so that a generally uniform and flat bottom surface for the cathode assembly 26 is formed. A separator disk 48 may be affixed to the bottom surface of the cathode assembly 26. The separator disk 48 may comprise the same separator material as, or a different separator material than, the material selected for the separator 16 of the first cathode segment 28 and the second cathode segment 38.

The cathode assembly 26 with a separator disk 48 may be inserted within an open end of a housing (not shown) for a battery. An anode 14 comprising zinc, electrolyte, and gellant may be placed within the void space formed within the center section 58 of the cathode assembly 26. An open end of the housing 18 may be closed by placing an end cap assembly including a seal, at least one current collector, and an end cap within the open end so that a length of housing extends above the end cap assembly and then crimping the extended housing length over the end cap assembly.

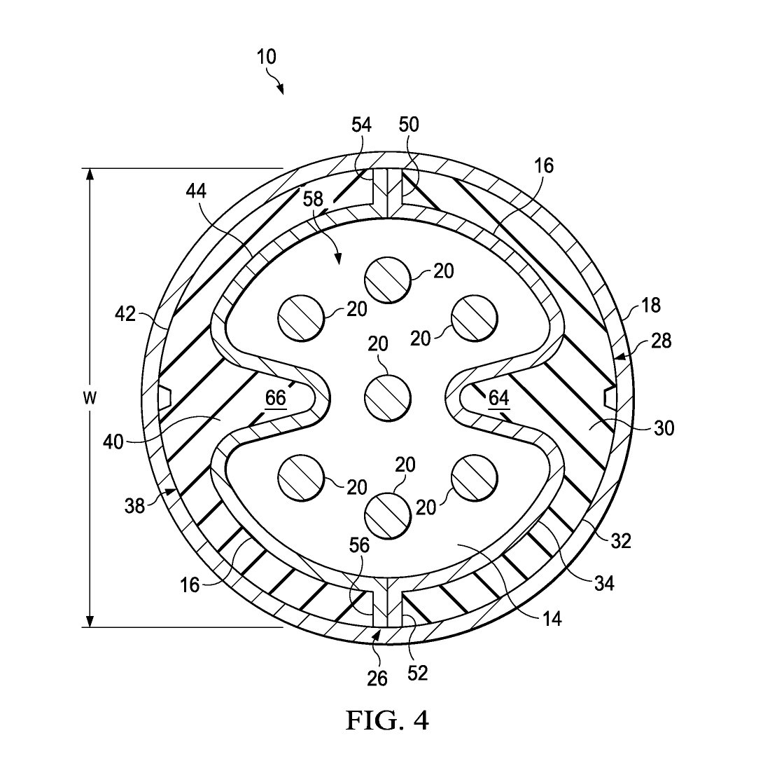

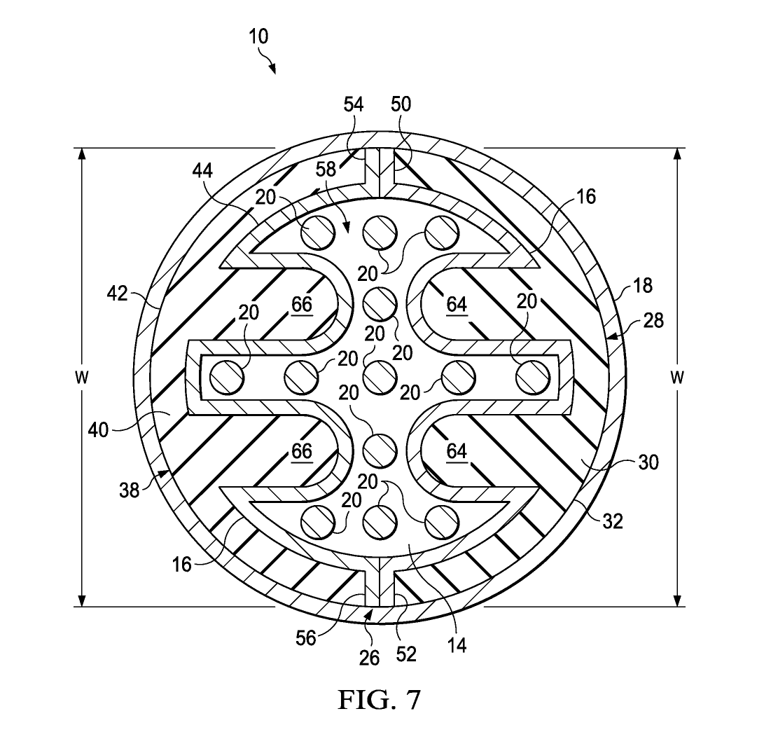

Referring now to FIGS. 4 and 7, there is shown a cathode assembly 26 that is included within a cylindrical housing 18 of battery 10. The cathode assembly 26 includes a first cathode segment 28, a second cathode segment 38, and a separator disk (not shown). An anode 14 comprising zinc, electrolyte, and gellant may be placed within the void space formed within a center section 58 of the cathode assembly 26. At least one current collector 20 is inserted into the anode 14 within the central section 58 of the cathode assembly 26.

The at least one current collector 20 may be placed at any location within the center section 58 of the cathode assembly 26. For example, one current collector 20 may be located within the center of the cylindrical housing 18. Alternatively, a first current collector 20 may be placed at one location of the cathode assembly 26, for example, about one half of a radius extending from the center of the cylindrical housing 18, and a second current collector 20 may be placed about one half of a different radius that the first current collector 20 extending from the center of the cylindrical housing 18. It should be appreciated that any number and location of current collectors 20 may be placed within the anode 14 in the center section 58 of the cathode assembly 26 as the battery designer determines necessary and practicable.

It has been found that conventional cathode assemblies, such as those including pellets that are re-compacted as used in a conventional alkaline battery, may not provide acceptable levels of discharge performance under a wide range of discharge profiles. Batteries including conventional cathode assemblies may provide acceptable performance under low or mid-drain discharge profiles, but provide poor discharge performance under high drain discharge profiles. Conversely, batteries including conventional cathode assemblies that are optimized for high drain discharge profiles may provide acceptable performance under high drain discharge profiles, but provide poor discharge performance under low or mid-drain discharge profiles. The cathode assembly of the present invention, when incorporated within a battery, provides improved discharge performance for low, mid, and high drain discharge profiles when compared to batteries that include conventional cathode assemblies.

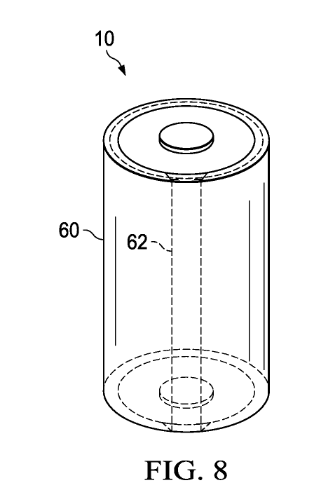

Referring now to FIG. 8, there is shown a battery 10 including a label 60 that has an indicator, or tester, 62 incorporated within the label to determine the voltage, capacity, state, and/or power of the battery 10. The label 60 may be a laminated multi-layer film with a transparent or translucent layer bearing the label graphics and text. The label 60 may be made from polyvinyl chloride (PVC), polyethylene terephthalate (PET), and other similar polymer materials. Known types of testers that are placed on batteries may include thermochromic and electrochromic indicators. In a thermochromic battery tester the indicator may be placed between the anode and cathode electrodes of the battery. The consumer activates the indicator by manually depressing a switch. Once the switch is depressed, the consumer has connected an anode of the battery to a cathode of the battery through the thermochromic tester. The thermochromic tester may include a silver conductor that has a variable width so that the resistance of the conductor also varies along its length. The current generates heat that changes the color of a thermochromic ink display that is over the silver conductor as the current travels through the silver conductor. The thermochromic ink display may be arranged as a gauge to indicate the relative capacity of the battery. The higher the current the more heat is generated and the more the gauge will change to indicate that the battery is good.

### Experimental Testing

### Performance Testing of Assembled AA Alkaline Primary Batteries

A AA battery including an exemplary cathode assembly of the present invention is assembled. The cathode assembly includes two cathode segments. Each cathode segment includes a cathode active segment and a separator. Each cathode active segment includes a first and a second curvilinear surface along a cross-sectional width and two cathode mating surfaces that run along the longitudinal lengths of the cathode active segments. The second curvilinear surfaces of both cathode active segments include a single lobe along each of the second curvilinear surfaces. A non-woven separator comprising a mix of polyvinyl alcohol and rayon fibers is affixed to the cathode mating surfaces and the second curvilinear surfaces of both cathode active segments. A separator disk comprising a nonwoven material that has a layer of cellophane material laminated to it is affixed to a bottom surface of the cathode assembly with the cellophane layer facing the cathode assembly. The cathode assembly is inserted into the open end of a cylindrical housing. An anode, along with an additional amount of electrolyte, is placed into a center section of the cathode assembly through the open end of the housing. An end cap assembly including a seal, one centrally located current collector, and an end cap is placed into the open end of the housing. The housing is then crimped over the end cap assembly to finish off the battery assembly process. The exemplary battery may then be conditioned and then discharged. The specific design features of the battery including this exemplary cathode assembly of the present invention, also referred to as Battery A, are included in Table 1 below.

A AA battery including another exemplary cathode assembly of the present invention is assembled. The cathode assembly includes two cathode segments. Each cathode segment includes a cathode active segment and a separator. Each cathode active segment includes a first and a second curvilinear surface along a cross-sectional width and two cathode mating surfaces that run the longitudinal lengths of the cathode active segments. The second curvilinear surfaces of both cathode active segments include two lobes along each of the second curvilinear surfaces. A non-woven separator comprising of a mix of polyvinyl alcohol and rayon fibers is affixed to the cathode mating surfaces and the second curvilinear surfaces of both cathode active segments. A separator disk comprising a nonwoven material that has a layer of cellophane material laminated to it is affixed to a bottom surface of the cathode assembly with the cellophane layer facing the cathode assembly. The cathode assembly is inserted into the open end of a cylindrical housing. An anode, along with an additional amount of electrolyte, is placed into a center section of the cathode assembly through the open end of the housing. An end cap assembly including a seal, one centrally located current collector, and an end cap is placed into the open end of the housing. The housing is then crimped over the end cap assembly to finish off the battery assembly process. The exemplary battery may then be conditioned and then discharged. The specific design features of the battery including this exemplary cathode assembly of the present invention, also referred to as Battery B, are included in Table 1 below.

A AA battery including a conventional cathode assembly is assembled. The cathode assembly includes four cathode pellets. Each pellet is cylindrical in shape and includes a central section that is void of cathode materials. The cathode pellets are inserted into the open end of a cylindrical housing and then re-compacted to form a uniform, cylindrical cathode assembly with a center section. A separator comprising of a non-woven layer laminated to a cellophane layer is inserted into the center section of the cathode assembly that is within the housing. An anode, along with an additional amount of electrolyte, is placed into the center section of the cathode assembly/separator. An end cap assembly including a seal, one centrally located current collector, and an end cap is placed into the open end of the housing. The housing is then crimped over the end cap assembly to finish off the battery assembly process. The conventional battery may then be conditioned and then discharged. The specific design features of the battery including a conventional cathode assembly, also referred to as Battery C, are included in Table 1 below.

TABLE 1
The design features of Battery A, Battery B, and Battery C.

| FEATURE | BATTERY A | BATTERY B | BATTERY C |
|---|---|---|---|
| Anode | | | |
| Zinc Weight | 4.86 g | 4.84 g | 4.91 g |
| Gelling Agent Weight | 0.027 g | 0.026 g | 0.018 g |
| Corrosion Inhibitor | 0.005 g | 0.005 g | 0.006 g |
| Weight | | | |
| Cathode | | | |
| EMD Weight | 11.13 g | 10.97 g | 11.14 g |
| Graphite Weight | 0.313 g | 0.405 g | 0.313 g |
| Complete Cell | | | |
| Total KOH Weight | 1.057 g | 1.062 g | 1.096 g |
| Total Water Weight | 2.410 g | 2.389 g | 2.545 g |
| Total ZnO Weight | 0.053 g | 0.053 g | 0.054 g |

Before the discharge performance testing, Battery A and B were allowed to rest for 24 hours at ambient conditions and then undergoes discharge performance testing. Battery C is exposed to a temperature conditioning regime. Under the temperature conditioning regime, Battery C is exposed to varying temperature over the course of 14 days. The battery is exposed to what may be referred to as one cycle over the course of a single 24 hour period. A cycle consists of exposing the battery to temperatures that are ramped down from about 28° C. to about 25° C. over the course of six and one half (6.5) hours. The battery is then exposed to temperatures that are ramped up from about 25° C. to about 34° C. over the course of four and one half (4.5) hours. The battery is then exposed to temperatures that are ramped up from about 34° C. to about 43° C. over the course of two (2) hours. The battery is then exposed to temperatures that are ramped up from about 43° C. to about 48° C. over the course of one (1) hour. The battery is then exposed to temperatures that are ramped up from about 48° C. to about 55° C. over the course of one (1) hour. The battery is then exposed to temperatures that are ramped down from about 55° C. to about 48° C. over the course of one (1) hour. The battery is then exposed to temperatures that are ramped down from about 48° C. to about 43° C. over the course of one (1) hour. The battery is then exposed to temperatures that are ramped down from about 43° C. to about 32° C. over the course of three (3) hours. The battery is finally exposed to temperatures that are ramped down from about 32° C. to about 28° C. over the course of four (4) hours. The cycle is repeated over the course of 14 days and then the battery undergoes discharge performance testing.

Performance testing includes discharge performance testing that may be referred to as the ANSI/IEC Motorized Toys Test (Toy Test). Battery A undergoes an accelerated Toy Test protocol where a constant load of 3.9 Ohms for 1 hour is applied to the battery and then the battery rests for a period of 11 hours. Battery C undergoes a Toy Test protocol where a constant load of 3.9 Ohms for 1 hour is applied to the battery and then the battery rests for a period of 23 hours. The respective Toy Test cycle is repeated until the cutoff voltage of 0.8 volts is reached. The service hours achieved is then reported.

Performance testing also includes discharge performance testing that may be referred to as the ANSI/IEC CD Player & Electronic Game Test (CD Player Test). Battery A undergoes an accelerated CD Player Test protocol where a constant load of 0.25 Amps for 1 hour is applied to the battery and then the battery rests for a period of 11 hours. Battery C undergoes a CD Player Test protocol where a constant load of 0.25 Amps for 1 hour is applied to the battery and then the battery rests for a period of 23 hours. The respective CD Player cycle is repeated until the cutoff voltage of 0.9 volts is reached. The service hours achieved is then reported.

Performance testing also includes discharge performance testing that may be referred to as the ANSI/IEC Audio Test (Audio Test). Battery A undergoes an accelerated Audio Test where a constant load of 0.100 Amps for 1 hour and then the battery rests for a period of 11 hours. Battery C undergoes an Audio Test where a constant load of 0.100 Amps for 1 hour and then the battery rests for a period of 23 hours. The respective Audio Test cycle is repeated until the cutoff voltage of 0.9 volts is reached. The service hours achieved is then reported.

Performance testing also includes discharge performance testing that may be referred to as the ANSI/IEC Toothbrush and Shaver Test (Toothbrush Test). The Toothbrush Test protocol includes applying a constant load of 0.5 Amps for 2 minutes to the battery and then the battery rests for a period of 15 minutes. This cycle is repeated until the cutoff voltage of 0.8 volts is reached. The service hours achieved is then reported.

Performance testing also includes discharge performance testing that may be referred to as the ANSI/IEC Digital Camera Test (DigiCam). The DigiCam Test protocol includes applying a 30 second pulse to that battery that includes a constant load of 1500 mW for 2 seconds followed immediately by 650 mW for 28 seconds. The cycle is repeated for 5 minutes, and then the battery rests for 55 minutes. This is repeated until the cutoff voltage of 1.05 volts is reached. The total number of pulses achieved is then reported.

### Performance Testing Results

Battery A and Battery C both undergo Toy, CD Player, Audio, Toothbrush, and DigiCam performance testing. Battery B undergoes Toothbrush performance testing. Battery A including an embodiment of the cathode assembly of the present invention provides increased performance on all discharge tests when compared to the performance of Battery C including a conventional cathode assembly. The embodiment of the cathode assembly of the present invention included within Battery A is able to contribute to improved discharge performance testing across all performance testing protocols when compared to Battery C. Battery A is able to provide a substantial improvement on mid and high drain discharge protocols while also providing an improvement on low drain protocols. Battery A when compared to Battery C, for example, provides an almost two-fold improvement on DigiCam testing while achieving double-digit improvement in mid drain tests and single digit improvements in low drain tests. Battery B is also able to provide substantial improvement on the high drain discharge protocol when compared to Battery C. Table 2 below summarizes the performance testing results. The % Difference column includes the percentage difference in performance from Battery A, or Battery B, with respect to Battery C.

TABLE 2
Performance testing results and comparisons for Battery A, Battery B,
and Battery C.

| TEST | BATTERY | BATTERY | BATTERY | % |
|---|---|---|---|---|
| PROTOCOL | A | B | C | DIFFERENCE |
| Toy | 9.38 | N/A | 9.12 | 2.9 |
| (Ser. Hours) | | | | |
| CD Player | 10.68 | N/A | 9.67 | 10.4 |
| (Ser. Hours) | | | | |
| Audio | 29.5 | N/A | 28.5 | 3.5 |
| (Ser. Hours) | | | | |
| Toothbrush | 5.1 | 5.1 | 4.5 | Battery A: 14.3 |
| (Ser. Hours) | | | | Battery B: 14.3 |
| DigiCam | 240 | N/A | 122 | 96.7 |
| (Pulses) | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. For example, a two cathode active segments may be formed. The top of the one of the cathode active segments may be placed adjacent to the bottom of the other cathode active segment. A separator may then be affixed along the cathode mating surfaces of the cathode active segments to form a first cathode active segment for use within a cathode assembly.

What is claimed is:

1. A cathode active segment for an electrochemical cell comprising:
at least one cathode active material;
a cross-sectional width including a first curvilinear surface;
a second curvilinear surface;
a longitudinal length; and
at least one cathode mating surface that extends along the longitudinal length.

2. The cathode active segment for an electrochemical cell of claim 1 further comprising a separator affixed to the at least one cathode mating surface.

3. The cathode active segment for an electrochemical cell of claim further comprising a separator affixed to the second curvilinear surface and the at least one cathode mating surface.

4. The cathode active segment for an electrochemical cell of claim 1 wherein the first curvilinear surface is an arc.

5. The cathode active segment for an electrochemical cell of claim 1 wherein the at least one cathode mating surface is planar.

6. The cathode active segment for an electrochemical cell of claim 1 wherein the cathode active material comprises manganese oxide, manganese dioxide, electrolytic manganese dioxide (EMD), chemical manganese dioxide (CMD), high power electrolytic manganese dioxide (HP EMD), lambda manganese dioxide, gamma manganese dioxide, beta manganese dioxide, silver oxide, nickel oxide, nickel oxyhydroxide, copper oxide, bismuth oxide, high-valence nickel compound, and mixtures thereof.

7. The cathode active segment for an electrochemical cell of claim 2 wherein the separator is affixed to the at least one cathode mating surface with an adhesive.

8. The cathode active segment for an electrochemical cell of claim 7 wherein the adhesive is selected from the group consisting of polyvinyl alcohol, cross-linked polyvinyl alcohol, hydroxyl ethyl cellulose, carboxy methyl cellulose, and cellulose acetate.

9. The cathode active segment for an electrochemical cell of claim 1 further comprising at least one lobe along the second curvilinear surface.

10. The cathode active segment for an electrochemical cell of claim 1 further comprising two lobes along the second curvilinear surface.

11. A cathode assembly for an electrochemical cell comprising:
a first cathode active segment comprising at least one cathode active material; a cross-sectional width including a first curvilinear surface, a second curvilinear surface, a longitudinal length, and at least one cathode mating surface that extends along the longitudinal length of the first cathode active segment:
a second cathode active segment comprising at least one cathode active material; a cross-sectional width including a first curvilinear surface, a second curvilinear surface, a longitudinal length, and at least one cathode mating surface that extends along a longitudinal length of the second cathode active segment; and
the at least one cathode mating surface of the first cathode active segment is positioned adjacent to the at least one cathode mating surface of the second cathode active segment.

12. The cathode assembly for an electrochemical cell of claim 11 further comprising a separator affixed to the at least one cathode mating surface of the first cathode active segment and a separator affixed to the at least one cathode mating surface of the second cathode active segment.

13. The cathode assembly for an electrochemical cell of claim 12 further comprising a separator affixed to the second curvilinear surface of the first cathode active segment and a separator affixed to the second curvilinear surface of the second cathode active segment.

14. The cathode assembly for an electrochemical cell of claim 11 wherein the first curvilinear surface of the first cathode active segment and the first curvilinear surface of the second cathode active segment are arcs.

15. The cathode assembly for an electrochemical cell of claim 11 wherein the cathode active material comprises manganese oxide, manganese dioxide, electrolytic manganese dioxide (EMD), chemical manganese dioxide (CMD), high power electrolytic manganese dioxide (HP EMD), lambda manganese dioxide, gamma manganese dioxide, beta manganese dioxide, silver oxide, nickel oxide, nickel oxyhydroxide, copper oxide, bismuth oxide, high-valence nickel compound, and mixtures thereof.

16. The cathode assembly for an electrochemical cell of claim 11 wherein the separator affixed to the at least one cathode mating surface of the first cathode active segment with an adhesive and the separator is affixed to the at least one cathode mating surface of the second cathode active segment with an adhesive.

17. The cathode assembly for an electrochemical cell of claim 16 wherein the separator is affixed to the second curvilinear surface of the first cathode active segment with an adhesive and the separator is affixed to the second curvilinear surface of the second cathode active segment with an adhesive.

18. The cathode assembly for an electrochemical cell of claim 11 further comprising at least one lobe along the second curvilinear surface of the first cathode active segment and at least one lobe along the second curvilinear surface of the second cathode active segment.

19. The cathode assembly for an electrochemical cell of claim 11 further comprising two lobes along the second curvilinear surface of the first cathode active segment and two lobes along the second curvilinear surface of the second cathode active segment.

20. An electrochemical cell comprising:
a housing having an outer surface, the housing including:
an anode;
a cathode assembly comprising:
a first cathode active segment comprising at least one cathode active material; a cross-sectional width including a first curvilinear surface, a second curvilinear surface, a longitudinal length, and at least one cathode mating surface that extends along the longitudinal length of the first cathode active segment;
a second cathode active segment comprising at least one cathode active material; a cross-sectional width including a first curvilinear surface, a second curvilinear surface, a longitudinal length, and at least one cathode mating surface that extends along a longitudinal length of the second cathode active segment; and
the at least one cathode mating surface of the first cathode active segment is positioned adjacent to the at least one cathode mating surface of the second cathode active segment;
a separator disposed between the anode and the cathode assembly; and
an electrolyte; and
a label affixed to the outer surface of the housing wherein the label includes a voltage tester.
